(19) United States
(12) Patent Application Publication
(10) Pub. No.: US 2010/0264612 A1
(43) Pub. Date: Oct. 21, 2010

(54) VEHICLE

(76) Inventor: GIAMPIETRO PAGANONI, Florano al Serio (BG) (IT)

Correspondence Address: Lonnie R Drayer, 6504 Cathedral Oaks Drive, Plant City, FL, 33565, US

(21) Appl. No.: 12/760,455

(22) Filed: Apr. 14, 2010

(30) Foreign Application Priority Data
Apr. 17, 2009 (EP) 09425145.1

(51) Int. Cl. B62B 13/08; B62B 13/10; B62K 5/04

(52) U.S. Cl. 280/16; 280/87.01

(57) ABSTRACT

A vehicle for transporting a person, in particular a disabled person, has a plurality of skis or other ground engaging elements for movement with respect to the ground. A support structure is provided with a seat, a support for the limbs of the vehicle user, a mechanism for steering the vehicle. A companion to the vehicle user is supported separate from the seat and from the skis, and connection element or base to which the support structure and at least one of the ground engaging elements are attached in an oscillating manner to take inclined positions with respect to the base connecting element.

### FIELD OF THE INVENTION

The present invention relates to a vehicle, in particular to a vehicle for the disabled provided with skis, or wheels.

### BACKGROUND OF THE INVENTION

There are known in the art various types of vehicles provided with skis to be used in alternative to skis and to snowboards. For example, U.S. Pat. No. 1,968,975 teaches a “snow scooter” provided with two short skis and a handlebar. A more technologically developed version of a “snow scooter” is taught in EP-A-1839992, which has the same inventor as the present application.

Vehicles such as “ski bikes” have also been known for some time; these are vehicles similar to bicycles without transmission members and provided with short skis in place of wheels. An example of a vehicle of this type is taught in U.S. D 446,474. These vehicles have also been adapted to allow use by disabled persons; preferred vehicles being in the form of “ski bikes” and sleds, according to the degree of disability of the vehicle user. For example, ski bikes have been provided with two rear skis in place of a single central ski. Sleds provided with one or more skis extending for the length of the vehicle have also been proposed, for example in CA 2,113,216. Ski bike type vehicles, even if provided with two rear skis, can only be used by persons with a reduced degree of disability, such as those with one amputated leg. Persons with more serious disabilities may be conveyed better by a sled.

### SUMMARY OF THE INVENTION

Known vehicles for conveying disabled persons are provided with a seat and one or two skis arranged centrally to the sled and which extend for the length thereof. These vehicles have the drawback of being difficult to maneuver and of not negotiating curves or of negotiating curves with difficulty, especially when a companion to the disabled person is also conveyed by the sled. The present invention provides a vehicle capable of negotiating curves and of transporting a severely disabled person and a companion to the disabled person.

According to the present invention, a vehicle comprises a support structure, a seat for a vehicle user, means for supporting one or more limbs of the vehicle user, means for guiding the vehicle and at least three ground engaging elements selected from skis and wheels attached to the support structure, and means for supporting a companion to the vehicle user that are separated from the ground engaging elements and attached to the support structure. As used herein and in the claims a ground engaging element is understood to be an element of a vehicle that contacts underlying dirt, pavement, grass, ice, snow or any other such surface to facilitate movement of the claimed vehicle along the surface.

In a preferred embodiment, the vehicle is a sled having one front ski or wheel and two rear skis or wheels. In an alternative embodiment, the skis are replaced by the same number of wheels, for use on grass or on a dirt road.

According to an aspect of the invention, the means for supporting the companion to the vehicle user comprise at least one footboard, positioned behind the seat; preferably two separate footboards are present. The footboards are mounted on brackets or forks which in turn are connected to the rear skis or wheels and can move, or oscillate, with brackets or forks and skis with respect to the support structure. According to another aspect of the invention, the footboards are pivoted to a tubular element attached to the support structure and oscillate with respect thereto to take inclined positions with respect to the support structure. According to yet another aspect of the invention, arms or similar means are present to transmit, from one footboard to the other, inclination with respect to the support structure, so that the skis are inclined in substantially the same manner to each other.

The invention presents numerous advantages with respect to prior art. The presence of at least three ground engaging elements and of a seat with support for the lower limbs allows an adequate level of safety to be provided for the vehicle user. The presence of a footboard to support the companion to the vehicle user allows even a seriously disabled person to use the vehicle and at least some ski-lifts to be used. Moreover, the presence of the footboard, or preferably of two footboards, separate with respect to the skis (or wheels) and preferably connected thereto by means of brackets or forks or supports, leads to the unexpected advantage of being able to negotiate even tight curves. In fact, not only is the companion to the vehicle user no longer positioned on the backs of the skis, as in prior art sleds and vehicles for the disabled, but the companion to the vehicle user can also contribute to driving the vehicle by moving his/her weight uphill or downhill together with the disabled person who is the vehicle user.

### BRIEF DESCRIPTION OF THE DRAWINGS

FIG. 1 is a perspective view of a vehicle according to the present invention.

FIG. 2 is a view of the rear part of the vehicle according to the present invention.

FIG. 3 is a side view of the vehicle according to the present invention.

FIG. 4 shows a detail of a base element of the vehicle according to the present invention.

FIG. 5 is a further detailed view of the base element of the vehicle according to the present invention.

FIG. 6 is a perspective view of the vehicle equipped with wheels for use on ground without snow.

### DETAILED DESCRIPTION OF THE INVENTION

The following description will refer first to an embodiment provided with skis, without however wishing to limit the scope of protection of the present application.

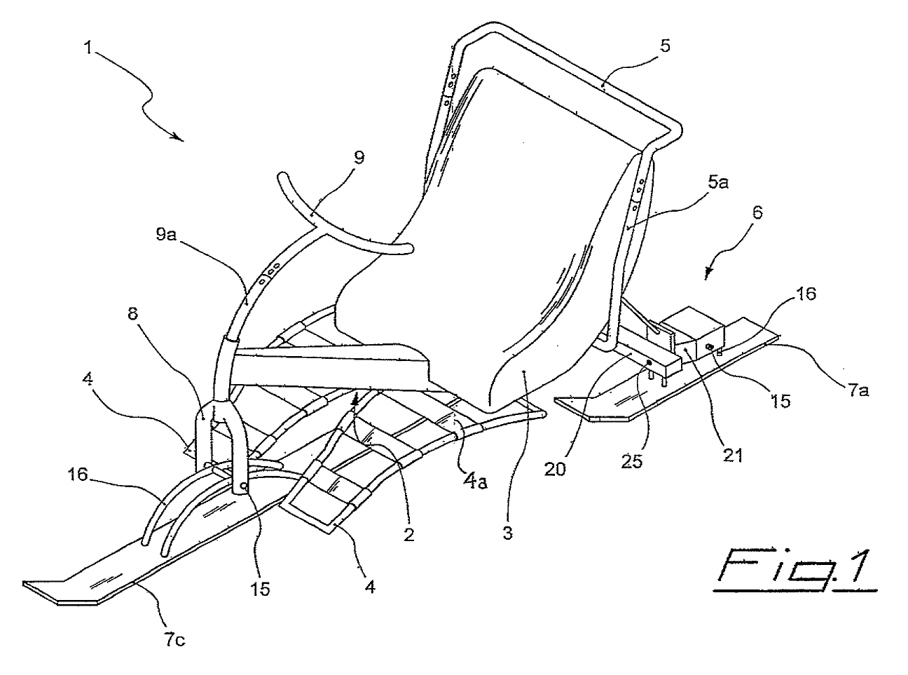

With reference to FIG. 1, a vehicle 1 according to the present invention comprises a support structure 2, such as a tubular element, to which a seat 3 is attached, means 4 for supporting the lower limbs and a handle 5 positioned behind the seat 3, for example, a frame provided with webs 4a, mesh or similar devices to support the legs of a vehicle user. As used herein the term “vehicle” is understood to have its' ordinary meaning of a conveyance that transports people or objects.

Located behind the seat 3 are means 6 for supporting a companion to the vehicle user standing and two rear support and ground engaging elements comprising skis 7a, 7b. A third ground engaging element, the ski 7c, is arranged in front of the seat 3, mounted on a fork 8 connected to a steering handlebar 9. As used herein and in the claims a ground engaging element is understood to be an element of a vehicle that contacts underlying dirt, pavement, grass, ice, snow or any other such surface. As used herein and in the claims the term “sled” is understood to have its' ordinary meaning of a vehicle mounted on ground engaging elements that are runners such as skis for use on snow and ice. A vehicle according to the present invention that is provided with ground engaging elements that are skis may referred to herein and in the claims as a sled.

It is desirable that a sled according to the present invention be provided with a means for slowing and stopping the movement of the sled using any suitable mechanism. While no braking mechanism is shown in the accompanying figures, an example of a suitable mechanism with a brake activator mounted on the handlebar is described in EP 1839992, incorporated herein by reference, in particular with respect to FIGS. 1, 5 and 6 and to paragraphs [0019] to [0022]. In the present invention, the rear brakes could be arranged on both rear skis 7a, 7b and comprise brake callipers that can be operated by a cable extending to a typical bicycle brake control positioned on the handlebar. In one embodiment, the brake levers are positioned on the sides of a ski and are joined by a cross-member connected to the brake operating cable. The brake levers are attached in a rotatable manner around a bush which allows oscillation thereof along a transverse axis with respect to the ski, by means of an attached lever which is associated with the bush and acts as abutment for the sheath of the brake operating cable. Elastic means, for example comprising a spring, act between the attached lever and the cross-member and allow the brake levers to be maintained normally in a raised position, i.e. a non-braking position. Following operation of the brake by means of the typical bicycle control positioned on the handlebar 9, the operating cable overcomes the opposing force of the spring and allows oscillation of the brake levers until reaching a position of engagement with the snow.

The seat 3 and the means 4 for supporting the lower limbs are preferably provided with safety belts, or similar means known in the art and not shown here, to restrain the disabled vehicle user to the vehicle and prevent him/her from falling off during use.

The handlebar 9 may be extensible and retractable in an attached portion 9a in a telescoping manner, where it can be attached in a known manner, for example using a nut and bolt, at different heights so that it can adopt different positions. In the case in which the vehicle user has difficulty in using his/her upper limbs, the handlebar 9 is extended above and over the seat 3 in a position (not shown in the figures) in which it can be controlled easily by the companion to the vehicle user standing on the means 6 for supporting a companion to the vehicle user located behind the seat 3 in the rear part of the vehicle.

In the case in which the vehicle user is able to control the handlebar 9, this is set in the most appropriate retracted position (i.e. the one position in the accompanying figures), while the companion to the vehicle user grips the grab bar 5 arranged behind the seat 3. Preferably, the grab bar 5 is also extensible and retractable in the same telescoping manner as stated above for the handlebar 9, so that it can be adjusted as a function of the height of the companion to the vehicle user and can be lowered when the companion to the vehicle user is required to grip the handlebar 9, after extension thereof; for this purpose the grab bar 5 can slide in a mating portion 5a in a telescoping manner and can be attached thereto in a plurality of positions.

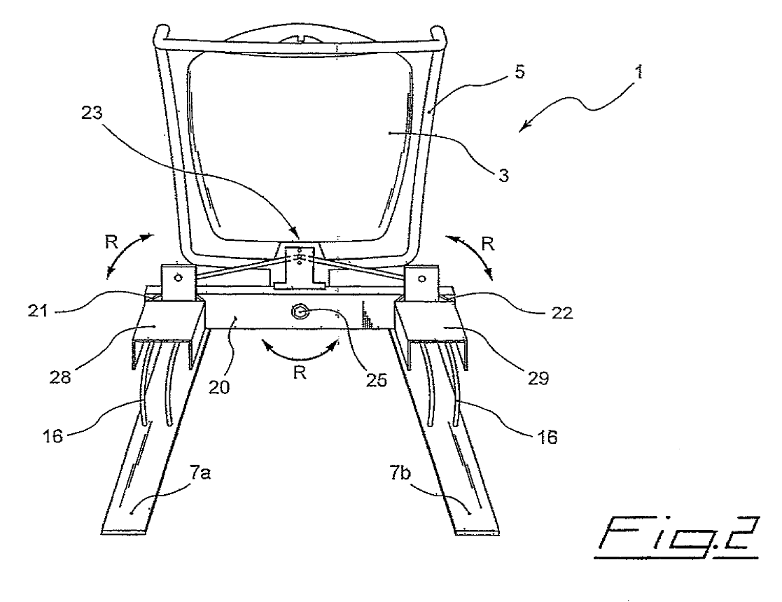

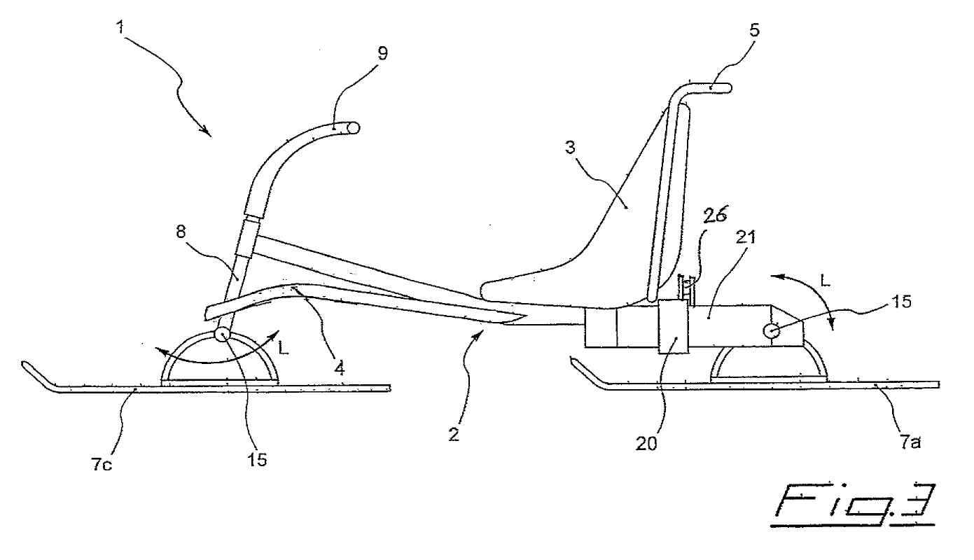

As can be seen in FIG. 2, which shows the rear part of a sled according to the present invention, the skis 7a, 7b are attached to a base connecting element 20, by means of forks 21, 22. In fact, the rear skis 7a, 7b are attached to the forks 21, 22 in a pivoting manner by means of a bracket 16 and a shaft 15, around which the skis can rotate in a plane perpendicular to the axis of the shaft 15, as indicated by the arrow L of FIG. 3.

The front ski 7c is also attached to the fork 8 of the handlebar 9 in a pivoting manner by means of a bracket 16 and of a shaft 15, around which the ski can rotate in a plane perpendicular to the axis of the shaft 15.

The support means 6, i.e. the footboards, for the feet of the companion to the vehicle user are separate from the skis 7a, 7b and, in the embodiment shown comprise two footboards 28, 29, having an inverted U-shaped cross section, arranged on the upper part of the forks 21, 22. In this manner, the companion to the vehicle user standing behind the seat 3 does not place his/her feet directly on the rear skis 7a, 7b.

The footboards 28, 29 are attached in a removable manner, for example by means of a bolt, to the arms of the corresponding fork 21, 22. The support structure 2 of the sled is also attached to the base element, or cross-member 20, by means of a plate 23.

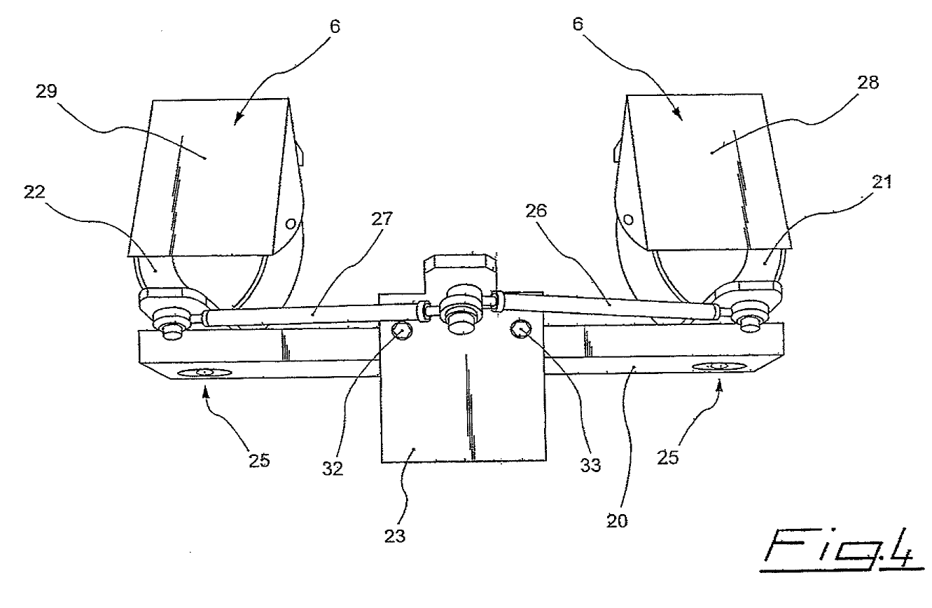

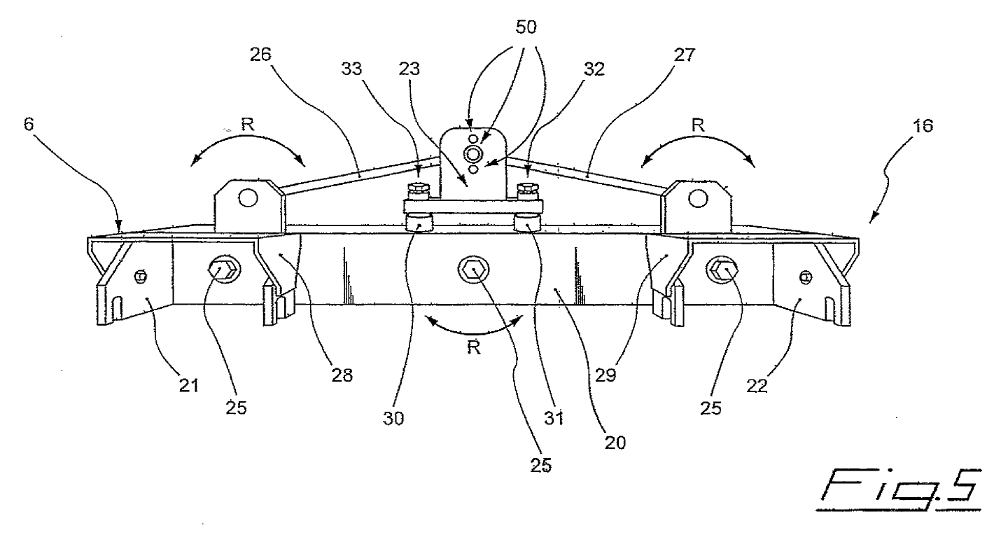

As will be described in more detail below, with particular reference to FIGS. 4 and 5, the rear skis 7a, 7b attached to the forks 21, 22 and the support structure 2 attached to the plate 23, are mounted so that they can oscillate, or vary the inclination thereof with respect to the base connecting element 20. FIGS. 4 and 5 show in detail the base connecting element 20, or cross-member, to which the support structure 2 and the two rear skis 7a, 7b are attached in an oscillating manner.

As used herein and in the claims the term “attached in an oscillating manner” is understood to mean that the method of constraining the rear ground engaging elements 7a, 7b and the support structure 2 allows inclined positions to be taken with respect to the base connecting element 20. In other words, the constraining means allow the rear skis 7a, 7b and the support structure 2 to change their inclination with respect to the base connecting element 20 to which they are attached.

The two forks 21, 22 and the plate 23 can oscillate with respect to the base element 20 by means of suitable constraining means comprising three bolts 25 mounted in a rotatable manner, for example on corresponding ball bearings, not shown in the figures.

Rotation around the axes of the bolts 25 allows variation of the inclination (oscillation) of the forks 21, 22 and of the plate 23 with respect to the base element 20, as indicated by the arrows R in FIGS. 2 and 5. It would also be possible to use other known constraining means, which allow the forks 21, 22 and the plate 23 to be pivoted, or attached in an oscillating manner, to the base connecting element 20.

As can be seen in particular with reference to FIG. 5, oscillation of the plate 23 and of the support structure 2 attached thereto with respect to the base element 20 is limited and regulated by means of a plurality of elastic elements 30, 31, which act as shock absorbers, and of a plurality of adjustment screws 32, 33. The annular elastic elements 30, 31 are arranged between a lower surface of the plate 23 and an upper surface of the base element 20, so that following oscillation of the plate around the bolt 25 to take a position inclined with respect to the base element, the elastic elements limit the maximum inclination that can be reached and simultaneously provide an opposing elastic force during the compression transient.

In the embodiment shown in FIG. 5 the elastic elements comprise two disks 30, 31, made of an elastic material such as an elastomer. The disks 30, 31 each have a passageway therethrough to receive a bolt 25 and are arranged laterally, in a symmetrical manner, with respect to a bolt 25 which allows oscillation of the plate 23 and of the support structure 2 attached thereto, with respect to the base element 20.

According to the side towards which inclination of the support structure 2 of the vehicle is required to be varied, for example to negotiate a curve, the elastic element 30, 31 on the side towards which the weight is shifting will be compressed. The disks 30, 31 perform a function similar to that of two shock absorbers and prevent the plate 23 from abutting against the base element 20 when the inclination of the support structure 2 is changed, for example to negotiate a curve or at least to perform a change in the direction of the movement of the sled.

The adjustment screws 32, 33, which can be operated manually, allow adjustment of the position of maximum inclination that the plate 23 and the support structure 2 can reach with respect to the base connecting element 20. Other known elastic means, such as a pair of springs, can be used in place of the discs without departing from the scope of protection of the present invention.

In the embodiment of the vehicle shown in the accompanying figures, the forks 21, 22, attached in an oscillating manner to the base element 20, are mutually interconnected so as to oscillate by a same arc around their respective pivots; alternatively, in an embodiment not shown in the accompanying figures, the forks are independent from each other. Moreover, in the embodiment shown, the forks are also connected to the support structure 2, which is also mounted in an oscillating manner on the connecting element, or base 20. In this manner the seat and fork rotate, or oscillate, together, with the advantage of improving and facilitating the negotiation of curves.

In FIGS. 4 and 5, the forks 21, 22 are connected to the plate 23 by means of a rigid connection means comprising, for example, tie-rods 26, 27. In this embodiment, oscillation of the support structure 2 and of the rear skis 7a, 7b with respect to the base element 20 is not independent, as the forks 21, 22 of the rear skis are attached rigidly to the plate 23 and therefore to the support structure 2. Consequently, the inclination reached by the support structure 2 and by the seat 3 of the sled, for example while negotiating a curve, is given by the inclination of the rear skis 7a, 7b, and vice versa.

Rigid transmission of the inclination between the plate 23 and the two forks 21, 22 by means of the tie rods 26, 27 can be regulated. The plate 23 is provided with three holes 50 to which the tie-rods 26, 27 can be attached. In this manner, an angle of rotation of both the forks 21, 22 around the respective bolts 25, will correspond to a specific angle of rotation of the plate 23 around the bolts 25, accentuated to a greater or lesser degree depending on which of the holes 50 is used for attaching the tie-rods 26, 27.

In a further alternate embodiment of the vehicle, the forks 21, 22 are independent so that the rear skis 7a, 7b connected thereto can oscillate with respect to the base element 20 independently from each other and independently with respect to the support structure 2 of the sled.

A vehicle according to the present invention ensures correct steering during curves and during changes in direction, as the vehicle user can move his/her weight inclining the support structure 2 with respect to the base element 20. The seat 3, attached to the support structure 2, can be inclined laterally with respect to the direction of travel so that the weight of the vehicle user can be correctly shifted to facilitate negotiation of curves.

As mentioned, the rear ground engaging elements 7a, 7b can also oscillate, i.e. they can be inclined with respect to the base connecting element 20 allowing the companion to the vehicle user to move his/her weight in an appropriate manner in order to negotiate curves correctly, as if skiing on two normal skis. In fact, the companion to the vehicle user remains standing on the support footboards 28, 29 which are attached to the forks 21, 22 of the rear ground engaging elements 7a, 7b and which therefore move therewith.

On a curve, the companion to the vehicle user moves his/her weight on the footboards 28, 29 causing oscillation of the skis 7a, 7b that are attached to the forks 21, 22, allowing the inclined position required to negotiate a curve, or to change direction, to be reached. As the skis are connected to each other and to the structure 2 by means of the plate 23, when the skis are inclined, the structure 2 and consequently the seat 3, the vehicle user and the front ski 7c reach a substantially corresponding inclination. Moreover, the changes in direction can also make use (in particular with flat skis) of the rotation of the handlebar 9 and of the front ski 7a attached thereto, by the vehicle user, or by the companion to the vehicle user gripping the handlebar in the extended position.

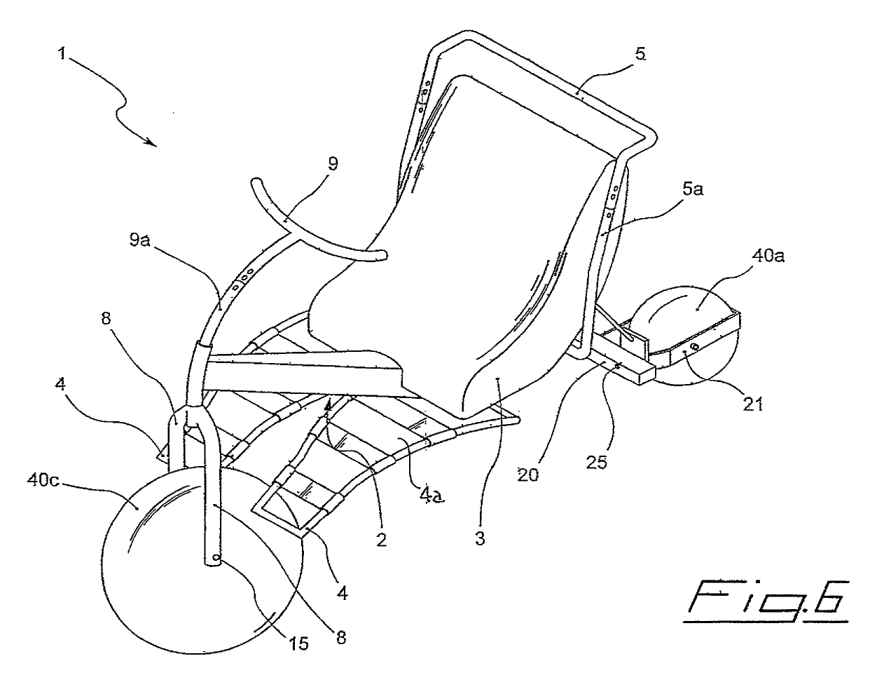

FIG. 6 is a perspective view of an alternate embodiment of the present invention in which the vehicle is provided ground engaging elements that are wheels 40a-40c to allow use of the vehicle on ground without snow, such as on grass. As shown in FIG. 6, the front wheel 40c is mounted to the end fork 8 of the handlebar 9 in place of the front ski 7c, while the rear wheels 40a, 40b are mounted to the forks 21, 22 in place of the rear skis 7a, 7b.

Operation of the vehicle is substantially the same as previously described in relation to the embodiment provided with skis as ground engaging elements, with the sole exception of the braking means, which use the operating cable of the sled to control adequate means movable from a position engaged with the wheel to a position disengaged therefrom. Unlike the embodiment provided with skis, the support means for the companion to the vehicle user, and in particular the footboards 28, 29, are preferably not attached to the upper part of the forks 21, 22, as they must allow passage of the rear wheels 40a, 40b. For this reason, the footboards 28, 29 are attached in a cantilevered position to the inner arm of the forks 21, 22, and can therefore oscillate with respect to the base element 20. In this embodiment, it is also possible for only one footboard to be present, mounted centrally on the base 20, and for the forks of the wheels to be mounted without oscillation but with appropriate convergence.

It is to be understood that the following claims are intended to cover all of the generic and specific features of the invention herein described, and all statements of the scope of the invention which, as a matter of language, might be said to fall there between.

1. A vehicle for transporting people, comprising:
(a) a support structure;
(b) a seat fixed to the support structure for accommodating a vehicle user;
(c) a ground engaging support structure fixed to the support structure forward of the seat and two ground engaging support structures fixed to the support structure rearward of the seat;
(d) a means for steering the vehicle;
(e) a means for supporting a companion to the vehicle user separated from the seat and from the ground engaging elements.

2. The vehicle according to claim 1, wherein the ground contacting elements comprise skis.

3. The vehicle according to claim 1, wherein the ground contacting elements comprise wheels.

4. The vehicle according to claim 1, further comprising a base connecting element to which the support structure and at least one of the ground engaging elements are attached in an oscillating manner to take inclined positions with respect to the base connecting element.

5. The vehicle according to claim 4, wherein the support structure is connected to a plate attached in an oscillating manner to the base connecting element.

6. The vehicle according to claim 5, wherein each of the ground contacting elements is attached to a fork attached in an oscillating manner to the base connecting element to allow the ground contacting element to be inclined with respect to the base connecting element.

7. The vehicle according to claim 6, wherein the means for supporting the companion to the vehicle user comprises at least one footboard positioned behind the seat, the footboard or footboards being connected to the forks and movable with the rear ground connecting elements with respect to the base connecting element.

8. The vehicle according to claim 7, further comprising rigid connection means for transmitting the inclination between the support structure and the footboards.

9. The vehicle according to claim 8, wherein the rigid connection means include at least one tie rod for connection of each of the forks to the plate.

10. The vehicle according to claim 5, further comprising at least one elastic element arranged between the plate and the base element to adjust the degree of inclination of the support structure with respect to the base element.

11. The vehicle according to claim 10, wherein the elastic elements are two disks made of elastic material arranged symmetrically with respect to the point in which the plate is attached in an oscillating manner to the base connecting element.

12. The vehicle according to claim 10, further comprising means for adjusting the maximum inclination of the plate with respect to the base connecting element.

13. A vehicle for transporting people, comprising:
(a) a support structure;
(b) a seat fixed to the support structure for accommodating a vehicle user;
(c) a ski fixed to the support structure forward of the seat and two skis fixed to the support structure rearward of the seat, a base connecting element to which the support structure and at least one of the skis is attached in an oscillating manner to take inclined positions with respect to the base connecting element, each of the skis is attached to a fork attached in an oscillating manner to the base connecting element to allow the ski to be inclined with respect to the base connecting element, and the support structure is connected to a plate attached in an oscillating manner to the base connecting element;
(d) a means for steering the vehicle;
(e) footboards for supporting a companion to the vehicle user separated from the seat and from the skis, the footboards being connected to the forks and movable with the rear skis with respect to the base connecting element.

14. The vehicle according to claim 13, further comprising rigid connection means for transmitting the inclination between the support structure and the footboards.

15. The vehicle according to claim 14, wherein the rigid connection means include at least one tie rod for connection of each of the forks to the plate.

16. The vehicle according to claim 15, further comprising at least one elastic element arranged between the plate and the base element to adjust the degree of inclination of the support structure with respect to the base element.

17. The vehicle according to claim 16, wherein the elastic elements are two disks made of elastic material arranged symmetrically with respect to the point in which the plate is attached in an oscillating manner to the base connecting element.

18. The vehicle according to claim 13, further comprising means for adjusting the maximum inclination of the plate with respect to the base connecting element.

19. A vehicle for transporting people, comprising:
(a) a support structure;
(b) a seat fixed to the support structure for accommodating a vehicle user;
(c) a wheel fixed to the support structure forward of the seat and two wheels fixed to the support structure rearward of the seat, a base connecting element to which the support structure and at least one of the wheels is attached in an oscillating manner to take inclined positions with respect to the base connecting element, each of the wheels is attached to a fork attached in an oscillating manner to the base connecting element to allow the wheel to be inclined with respect to the base connecting element;
(d) a means for steering the vehicle;
(e) footboards for supporting a companion to the vehicle user separated from the seat and from the wheels, the footboards being connected to the forks and movable with the rear wheels with respect to the base connecting element.

20. The vehicle according to claim 19, further comprising rigid connection means for transmitting the inclination between the support structure and the footboards, the rigid connection means including at least one tie rod for connection of each of the forks to the plate, at least elastic element arranged between the plate and the base element to adjust the degree of inclination of the support structure with respect to the base element.
